(19) United States
(12) Patent Application Publication
(10) Pub. No.: US 2002/0120842 A1
(43) Pub. Date: Aug. 29, 2002

(54) Method, apparatus and computer program product for interoperable cryptographic material

(76) Inventors: Helge Bragstad, Barums Verk (NO); Edwin J. Dolph, Austin, TX (US); James A. McLaughlin, Austin, TX (US); Marc Talbot, Kuala Lumpur (MY)

Correspondence Address: SCHLUMBERGER AUSTIN TECHNOLOGY CENTER, ATTN: PEHR B. JANSSON, INTELLECTUAL PROP LAW DEPT., 8311 NORTH FM 620, AUSTIN, TX, 78726, US

(21) Appl. No.: 09/993,899

(22) Filed: Nov. 24, 2001

Related U.S. Application Data
(60) Provisional application No. 60/253,864, filed on Nov. 29, 2000.

(51) Int. Cl. H04L 9/00

(52) U.S. Cl. 713/156

(57) ABSTRACT

In one aspect, according to a first form of the invention, a method for accessing cryptographic material includes creating cryptographic material, by a first Cryptographic-related application programming interface (“API”), in response to a request by a first application compatible with the first Cryptographic-related API. A supplemental aspect of the cryptographic material is created by a supplemental method for the first cryptographic API. The supplemental aspect includes information for rendering the cryptographic material compatible with a second Cryptographic-related API. The cryptographic material is then accessed for a second application by the second Cryptographic-related API.

### CROSS-REFERENCE TO RELATED APPLICATION

This application is related to U.S. Provisional Application No. 60/253,864, filed Nov. 29, 2000, entitled “Interoperable Cryptographic Material,” Bragstad et al., which is hereby incorporated herein by reference, and for which is hereby claimed the benefit of under 35 U.S.C. 119(e).

### BACKGROUND

1. Field of the Invention

This invention relates to the use of cryptographic material in computing systems, and more particularly to interoperability issues that arise from access to cryptographic material by numerous diverse computer applications.

2. Related Art

Cryptography plays a central role in providing secure electronic data communication. This includes authenticating users and ensuring their privacy. A smart card, i.e., a card having a microprocessor, is an effective tool for ensuring a strong bind between secret cryptographic keys and a person using electronic data communication because the cryptographic keys reside in the smart card's memory and can only be used for computations by the card's processor. Moreover, use of a smart card for security tends to ensure legitimacy of the card holder because the card holder must unlock the card using a shared secret in order to use the keys. Nevertheless, it is acknowledged to be a substantial task to issue and manage cryptographic keys in a way that provides a level of trust required for secure communication. It is therefore advantageous for several applications running on a host computer to use one set of cryptographic keys stored on a smart card, instead of each application taking on the task of key management.

Many applications that take advantage of smart cards today use high level, Cryptographic-related application programming interfaces (“API's”). Dominant Cryptographic-related API's today include Public-Key Cryptography Standard (“PKCS”) #11, by RSA Security, CryptoAPI, which is part of the Microsoft Windows operating system, and Common Data Security Architecture (“CDSA”) by The Open Group. A “Cryptographic-related API,” as used herein, refers to an API, often, but not necessarily conforming to an industry standard and not necessarily limited to one of the above mentioned API's, for generating, manipulating, or accessing cryptographic material, such as key certificates and keys, including public keys and private keys. (“Accessing,” as the term is used herein, includes reading or writing, and includes executing programs on the smart card.) Smart card vendors often provide libraries that adhere to the PKCS #11 specification, CDSA-modules for interfacing with applications that use the CDSA architecture, as well as Cryptographic Service Providers (“CSP”) for interfacing with applications that use the CryptoAPI architecture. However, even when using a smart card for cryptographic material, two independent applications running on the host are still likely to have a problem if one application is based on one Cryptographic-related API, e.g., PKCS #11, and the other application is based on another Cryptographic-related API, e.g., CryptoAPI, because so much effort is needed to provide successful interoperability. Worse still, even two applications using the same Cryptographic-related API may not operate correctly, with or without a smart card, since the applications may specify or interpret attributes of cryptographic objects differently. This is a particular problem with PKCS #11 based applications, because PKCS #11 is so flexible. Therefore, a need exists for improvements in interoperability of cryptographic materials used in common by numerous applications. This need is not limited to the context of cryptographic material stored on a smart card, but is particularly acute in this area.

### BRIEF DESCRIPTION OF THE DRAWINGS

FIG. 1 illustrates an interface that enables applications compatible with respective different cryptographic protocols to use cryptographic material in common, according to an embodiment of the invention.

FIG. 2 illustrates certain details concerning private keys, public keys and certificates, which are related to aspects of an embodiment concerning a first one of the cryptographic protocols.

FIG. 3 illustrates certain details concerning private keys, public keys and certificates, which are related to aspects of an embodiment concerning another of the cryptographic protocols.

FIG. 4 illustrates aspects of a common storage model, according to an embodiment of the invention.

FIG. 5 illustrates additional aspects of a common storage model that concern a default key container, according to an embodiment of the invention.

FIG. 6 illustrates additional aspects of a common storage model that concern the Windows operating system registry, according to an embodiment of the invention.

FIG. 7 illustrates a method that supplements a conventional method for creating a private key, according to an embodiment of the invention.

FIG. 8 illustrates a method that supplements a conventional method for creating a public key certificate, according to an embodiment of the invention.

FIG. 9 illustrates certain additional details of an aspect shown in FIG. 8 concerning the setting of a key specification, according to an embodiment of the invention.

FIG. 10 illustrates a computer system, according to an embodiment of the invention.

### DETAILED DESCRIPTION OF THE PREFERRED EMBODIMENT

The claims at the end of this application set out novel features which applicants believe are characteristic of the invention. The invention, a preferred mode of use, objectives and advantages, will best be understood by reference to the following detailed description of an illustrative embodiment read in conjunction with the accompanying drawings.

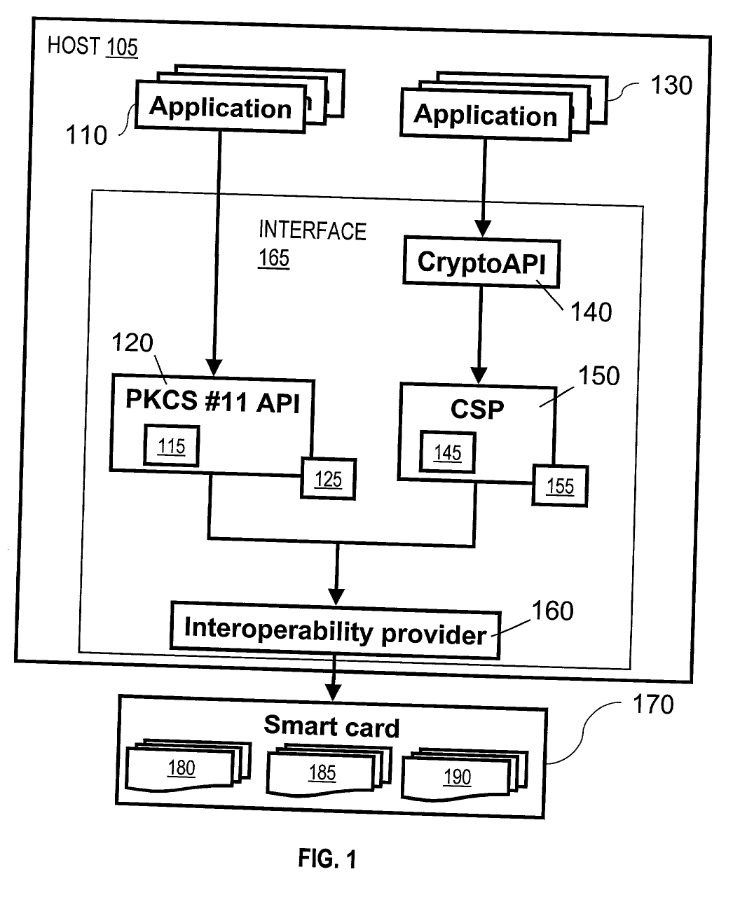

Referring to FIG. 1, an interface 165, according to an embodiment of the invention, enables PKCS #11 compatible applications 110 running on a host 105 to communicate with a smart card 170 through a PKCS #11 compatible API portion 120 of the interface 165, and other applications 130 to communicate with the same smart card 170 through Microsoft's conventional CryptoAPI 140, which invokes a smart-card-specific CSP 150 in the interface 165. The interface 165 makes it possible for both sets of applications 110 and 130 to read a common set of public key certificates 180 and a common set of public keys 185 that are stored on the smart card 170. Further, it makes it possible for the applications 110 and 130 to both use the same private keys 190 for cryptographic operations on the smart card 170.

In addition to the interface 165, a model is provided, according to an embodiment of the invention, for storing objects, e.g., cryptographic material such as public key certificates 180, public keys 185 and private keys 190 on the smart card 170 in a way that renders the objects accessible by both sets of applications 110 and 130. This storage model is a superset of the storage models of conventional PKCS #11 and CSP. A method 125 is provided for the PKCS #11 compatible API portion 120 of the interface 165 to populate the CryptoAPI compatible side of the common storage model accessed by CSP 150, as will be further described herein. Likewise, a method 155 is provided for the CSP 150 portion of the interface 165 to populate the PKCS #11 compatible side of the common storage model, as also will be further described herein. The methods 125 and 155 are transparent to an application 110 or 130 calling the API 120 or CSP 150.

In this fashion, first cryptographic material, such as a key or certificate described herein below, is created in response to a request from one of the applications 110 by a method 115 of the PKCS #11 compatible API 120, while additional information, as will also be described herein below, is created by a supplemental method 125 for the API 120, responsive to creating the cryptographic material. The additional information includes information for the CryptoAPI 140, i.e., information compliant with conventions of the CryptoAPI 140, so that the CryptoAPI 140 can also access the first cryptographic material via the interface 165. Likewise, second cryptographic material, such as a key or certificate described, is created in response to a request from one of the applications 130 by a method 145 of the CSP 150, while additional information is created by a supplemental method 155 for the CSP 150, responsive to creating the cryptographic material. In this case, the additional information includes information for the PKCS #11 API 120, i.e., information compliant with conventions of the PKCS #11 API 120, so that the PKCS #11 API 120 can also access the second cryptographic material via the interface 165. Accessing the first and second cryptographic material and the additional information includes, in particular, a common interoperability provider (“CIP”) 160 included in the interface 165 receiving requests from the PKCS #11 module 120, the supplemental method 125, the CSP 150 or the supplemental method 155, accessing the first cryptographic material and the additional information stored on the smart card 170, and passing it to the PKCS #11 module 120, the supplemental method 125, the CSP 150 or the supplemental method 155.

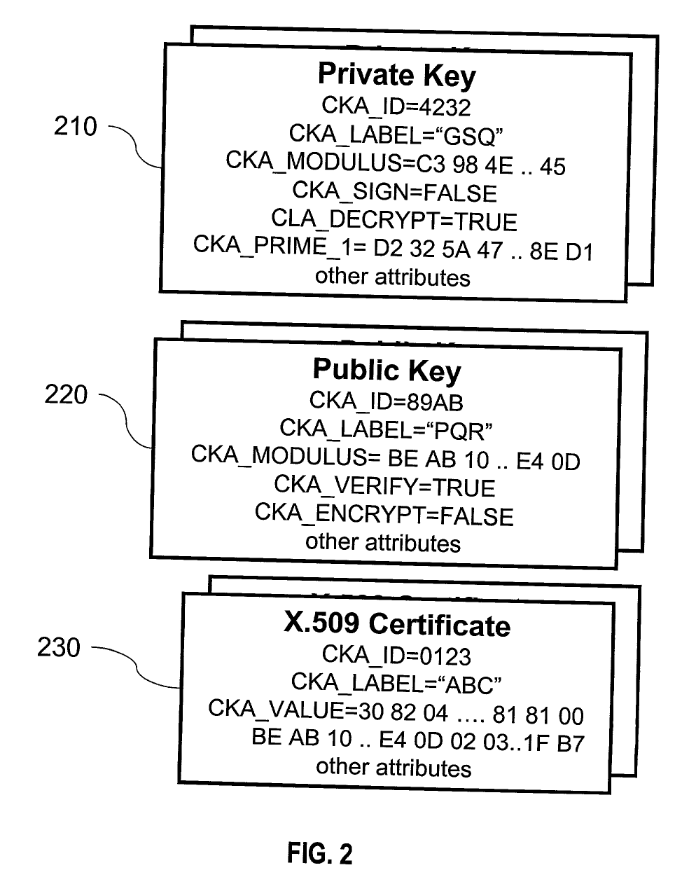

Referring to FIG. 2, certain details are shown concerning private keys 210, public keys 220 and certificates 230, which are object classes of particular significance to the invention. These details are related in the following description to aspects of an embodiment concerning the PKCS #11 standard. In the conventional PKCS #11 standard, each object is described entirely by a set of attributes, but conventionally there is no structure or relationship among objects that is exposed through the PKCS #11 API. Consequently, in the conventional PKCS #11 standard it is up to an application to use object attributes to build any such structure or relationships among objects. For example, an application may use a consistent CKA_ID attribute in common among a public key, private key and certificate which the application associates with one another. Also, in the conventional PKCS #11 standard the keys have attributes that determine key usage which a conventional PKCS #11 compliant API enforces to ensure that only operations allowed by these usage attributes can be performed. However, the PKCS #11 standard does not assume that the PKCS #11 API will understand the contents of a certificate, and certainly does not contemplate that the PKCS #11 API will enforce consistency between a key usage attribute and an attribute of a certificate.

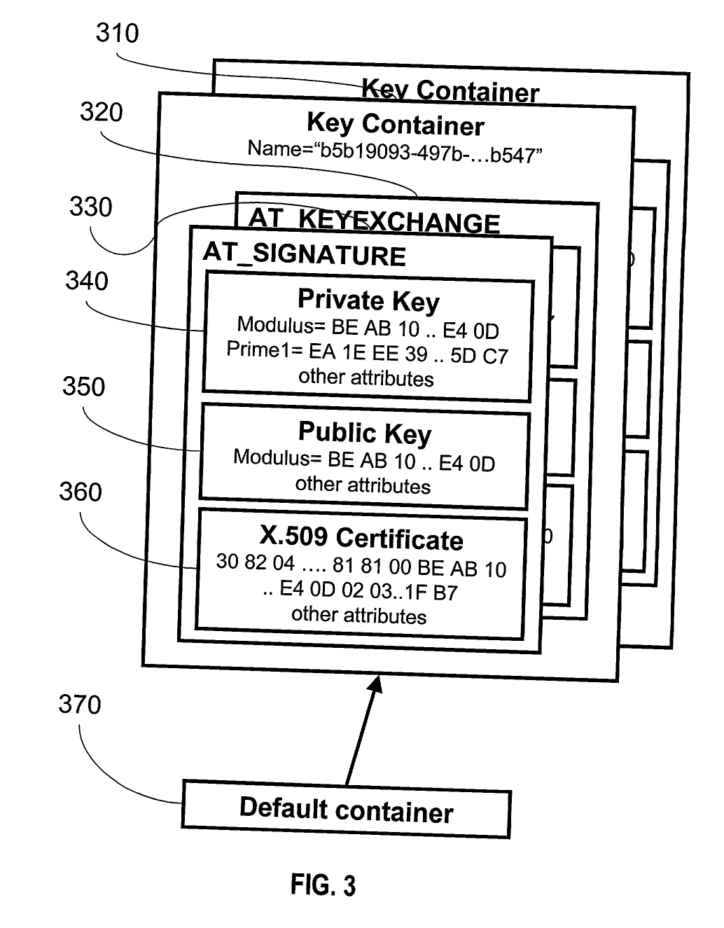

Referring to FIG. 3, certain details are shown concerning a private key 340, public key 350 and certificate 360. These details are related in the following description to aspects of an embodiment concerning CryptoAPI. Although CrytpoAPI is a protocol adopted and controlled by Microsoft Corporation and is not truly a standard in the formal sense of a method or structure mutually agreed upon and jointly controlled by numerous developers in an industry; nevertheless, due to its widespread use it is a “de facto standard” and may therefore be referred to herein as a “standard.” In the conventional CryptoAPI, a private key 340, its associated public key 350 and public key certificate 360 are always stored in a key container 310. A key container has a unique name used by Windows to look up the storage location of a certificate and key pairs, i.e., a public key and its associated private key. (CryptoAPI also has a notion of a default container 370 that will be chosen if the application attempts to access a container without specifying its name.) The key pair plus the associated public key certificate constitute a triplet that is stored either under an AT_KEYEXCHANGE 320 or an AT_SIGNATURE 330 key specification. (Although this might appear to indicate that a key is used for a specific cryptographic operation, the CryptoAPI does not enforce key usage based on the key spec. Rather, in many cases, a user is allowed only one key that is used both for signing and key exchange. Many applications use the AT_KEYEXCHANGE 320 as the default for key specification of such a dual use key.

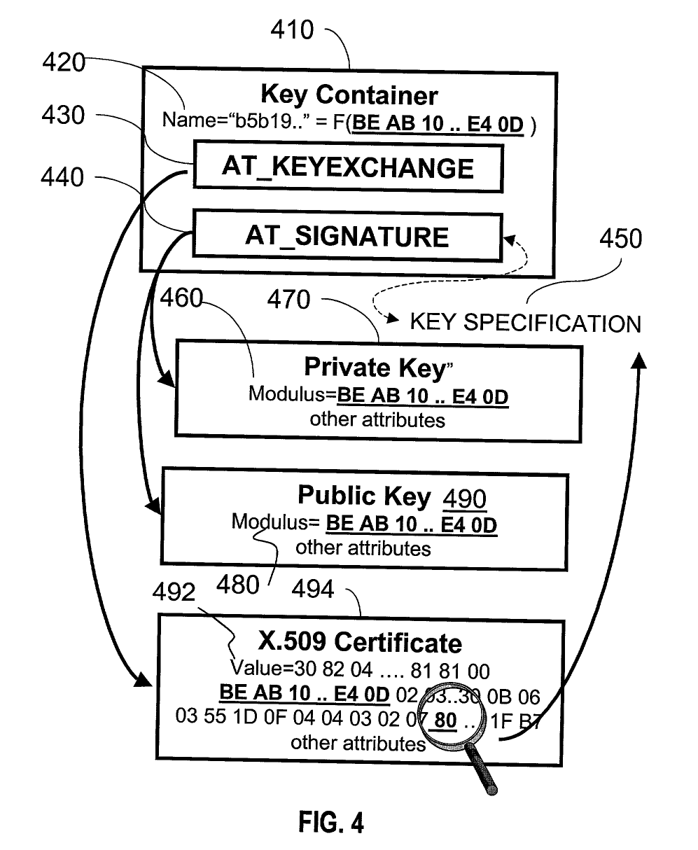

Referring to FIG. 4, aspects of a common storage model are illustrated, according to an embodiment of the invention. The model includes objects of class “key container” 410. A name 420 is used by the Windows operating system to identify the key container 410. Each key container 410 may have a number of key pairs, each key pair having a respective key specification 450, which has either the AT_KEYEXCHANGE 430 or AT_SIGNATURE 440 value. In other embodiments, the key specification has additional or different values. Each key pair includes a Private Key 470, a Public Key 490 and a X.509 Certificate 494. These three objects are associated with each other so that the private key can decrypt what has been encrypted by the public key, and so that the certificate contains the information of the same public key.

Cryptographic material, such as a private key 470 object or a X.509 certificate 494 object, is created, responsive to an application 110 requesting such creation. The material is created by a conventional method, C_Create Object 145 (FIG. 1) included as part of the PKCS ≠11 compliant API 120 (FIG. 1). According to the present embodiment, this conventional method 115 is augmented with supplemental method 125 (FIG. 1). Responsive to the conventional C_CreateObject method 115 creating the private key 470 or X.509 certificate 494 cryptographic material, the supplemental method 125 creates a key container 410, i.e., a supplemental aspect of the cryptographic material, unless the appropriate key container 410 has already been created. The container name is uniquely derived from the key pair, in a manner such that the name can be derived separately from the private key 470, the public key 490 and the certificate 494. That is, the method 125 generates a unique name 420 for the key container 410 by first creating a hash of the big endian representation of a certain RSA modulus. In the embodiment, the method for making the hash is that of Ronald L. Rivest, “The MD5 Message-Digest Algorithm,” RFC 1321. The RSA modulus is present within the value 492 of the X.509 certificate 494, and is a private key object attribute 460 and a public key object attribute 480. Then the method 125 ASCII encodes the sixteen byte long hash into a Windows GUID style format:

“n0n1n2n3-n4n5-n6n7-n8n9-nAnBnCnDnEnF”

where n0 is the 2 character hex representation of the first byte in the hash, n1 is the 2 character hex representation of the second byte, and so on through nF. Of course, other hashing and encoding methods are used in other embodiments.

As a consequence of this methodology, the key container name 420 can be derived from the key pair objects. This is useful in the event that a private key and the associated container name are lost and the private key is recovered from escrow, because the key container name 420 already known by the Windows operating system can be derived from the key pair.

If a key container 410 already exists for the key 470, then upon creation of a private key 470 method 125 derives the associated key container name 420 and locates this key container by looking through the key containers on the card 170 (FIG. 1) to see if there is one with the same key container name. If the key container 410 already exists and contains a certificate 494, the method 125 associates the private key 470 with the same key pair 498 as the certificate 494. If the key container 410 does not contain a certificate 494, then the methods 125 associates the private key 470 with a key pair 498 having the default key specification AT_KEYEXCHANGE 430.

Upon creation of a certificate 494, the method 125 extracts from the certificate value 492 information that specifies key usage, referred to herein as a “key usage attribute” or “key specification 450,” as previously described. If “keyEncipherment” is present in the key usage specifying information 450, then AT_KEYEXCHANGE 430 is indicated as the key specification 450. If either “digital Signature” or “nonRepudiation” are present in the key usage specifying information 450, then AT_SIGNATURE 440 is indicated. Otherwise, AT₁₃KEYEXCHANGE 430 applies as a default key specification 450.

Upon creation of a certificate 494, the method 125 also extracts the previously mentioned modulus from the X.509 certificate 494. The associated key container name 420 is then derived from the modulus in the certificate value 492 and the key container 410 is located, or if necessary created. The method 125 then associates the X.509 certificate 494 with a key pair under a key specification 450 extracted from the certificate value 492, as described above. If the Key Container 410 already exists and contains a Private Key 470, the method 125 associates this Private Key 470 with the same key pair as the X.509 Certificate 494, even if this means that the key specification of the key pair to which the Private Key 470 originally belonged will change in the process.

Many CryptoAPI applications assume the presence of a public key in a key container. In contrast, some popular PKCS #11 applications do not store the public key 490, or may even delete it after key pair generation. Therefore, upon creation of a X.509 certificate 494, the supplemental method 125 also creates a public key object 490 based on the information stored in the X.509 certificate 494. This public key 490 is not accessible through the PKCS #11 interface. It has the same CKA₁₃ PRIVATE attribute as the object from which it was derived so that information will not “leak out” if CKA_PRIVATE was TRUE.

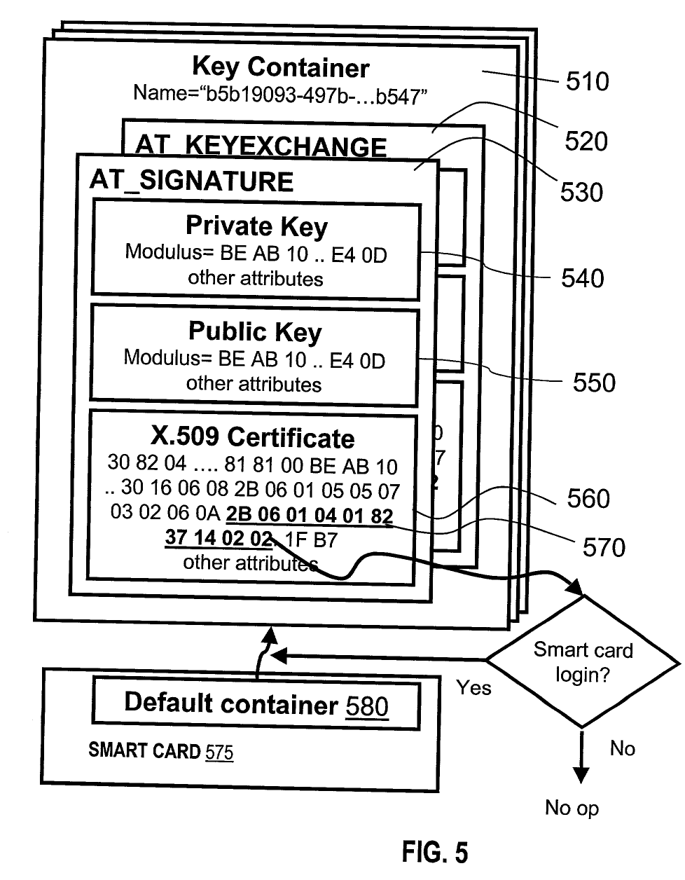

Referring to FIG. 5, additional aspects of a common storage model that concern a default key container are illustrated, according to an embodiment of the invention. Microsoft's CryptoAPI supports a default key container concept. A default key container is one that will be selected if an application tries to initiate contact with a key container without specifying a name. The Windows login process is an important application that uses this feature, because prior to login there is no user context and hence no preferred container name. According to an embodiment of the present invention, supplemental method 125 (FIG. 1) augmenting the PKCS #11 compliant API 120 and supplemental method 155 (FIG. 1) augmenting the CryptoAPI compliant CSP 150 both perform the following default key container related functions. During the process of storing a X.509 certificate 560 on a smart card 575, the certificate extensions of the certificate 560 being stored are searched for an extended key usage 570 that indicates smart card login. If such a key usage 570 is found, the method 125 or 155 sets a reference 580 on the smart card 575 to point to the key container 510 on the card in which this X.509 certificate 560 is being stored to indicate that this is the default container. Other algorithms could be also used for deciding if a container should be made the default container.

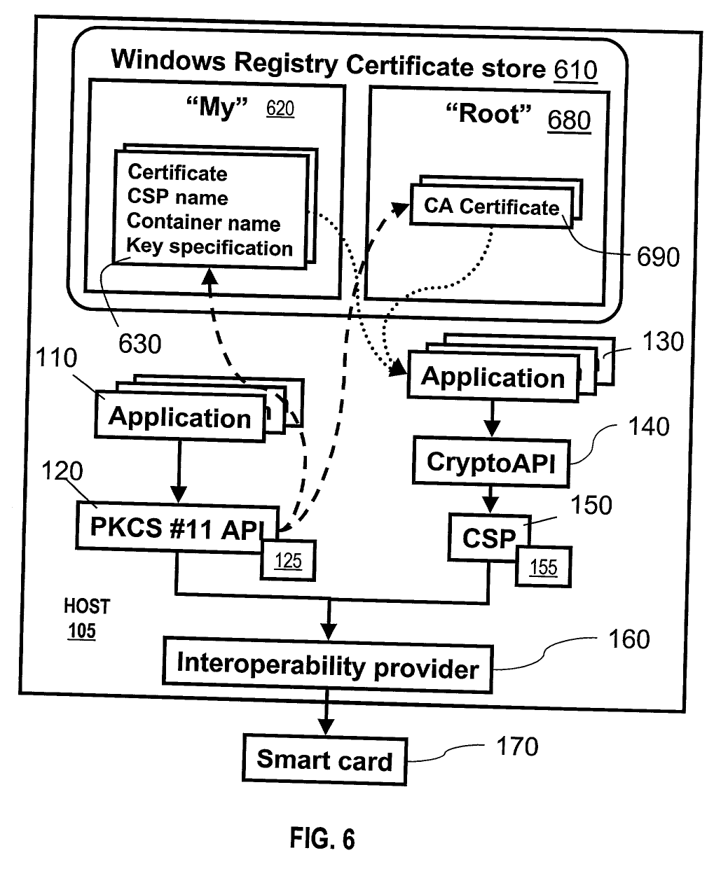

Referring to FIG. 6, additional aspects of a common storage model that concern the Windows operating system registry are illustrated, according to an embodiment of the invention. CryptoAPI applications 130 use certificate information 630 in the “My” certificate store 620 in the registry 610 of the Windows operating system to locate private keys, e.g., private key 340 (FIG. 3). In particular, the applications 130 use the information 630 about which CSP 150 to load, the name of the key container and key specification (AT_SIGNATURE or AT_KEYEXCHANGE) of the key pair where the private key is stored. Further, the applications 130 use CA certificates 690 that are present in the “Root” certificate store 680 to decide if a certain certificate, e.g., certificate 360 (FIG. 3), can be trusted. According to an embodiment of the present invention, supplemental method 125 augmenting the PKCS #11 compliant API 120 performs the following Windows registry related functions. Upon creation of a X.509 certificate 360 the method 125 also exports the certificate 360 to the Windows registry 610. If the certificate 360 is recognized to be a CA certificate 690, the method 125 attempts to store the certificate 360 in the “Root” branch 680 of the of the user's Windows registry certificate store 610. (Windows ensures that the user actually accepts that this certificate 680 becomes trusted.) If it is not recognized to be a CA certificate 680, the certificate 360 is exported to the “My” branch 620 of the user's Windows registry certificate store 610 with the information 630 about CSP name, key container name and key specification.

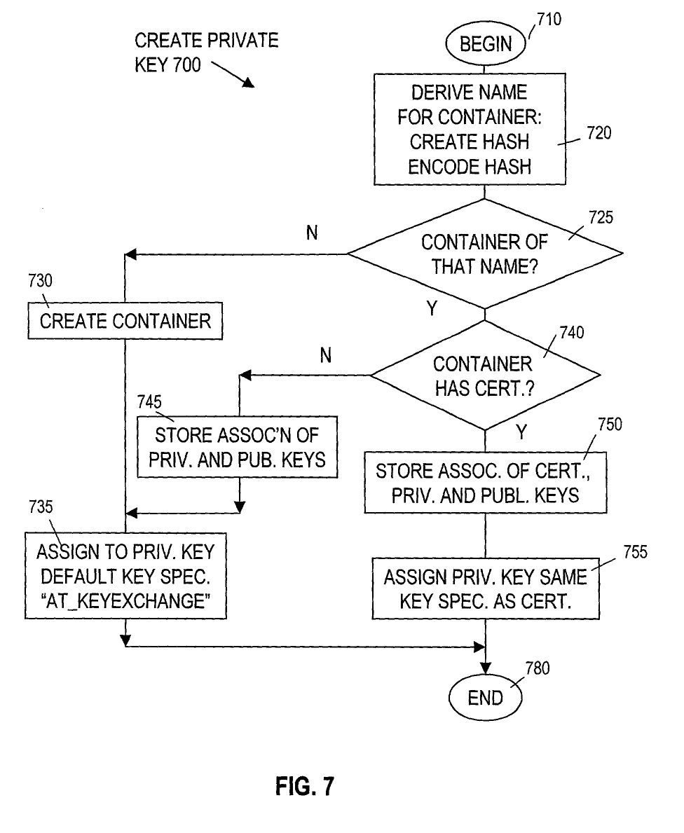

Referring now to FIG. 7, a method 700 is illustrated, according to an embodiment of the invention. Method 700 is included in method 125 (FIG. 1), and supplements conventional method 115 (FIG. 1) for creating a private key. The supplemental method 700 begins at 710 responsive to an application calling for the method 115 to create a private key. Next, at 720, a name is derived for the private key container from the key's associated public key. In the embodiment, this includes creating a hash and encoding the hash, as has been described herein above. Then, at 725, the names of all the containers on the smart card 170 (FIG. 1) are compared with the derived name to see if there is a container of that name on the smart card 170. If not, then at 730 a container is created and assigned the derived name. Then, at 735, the private key is assigned a default key specification “AT_KEYEXCHANGE,” and the method 700 ends at step 780. If there is a container with the derived name, then at 740 a determination is made whether the container has a certificate for the private key's associated public key. If not, then at 745 association of the private and public keys is stored, at 735 the private key is assigned the default key specification “AT_KEYEXCHANGE,” and the method 700 ends at step 780. If the container it does have a certificate for the private key's associated public key, then at 750 associations of the certificate, private key and public key are stored, at 755 the private key is assigned the same key specification as the certificate and the public key, and the method 700 ends at step 780.

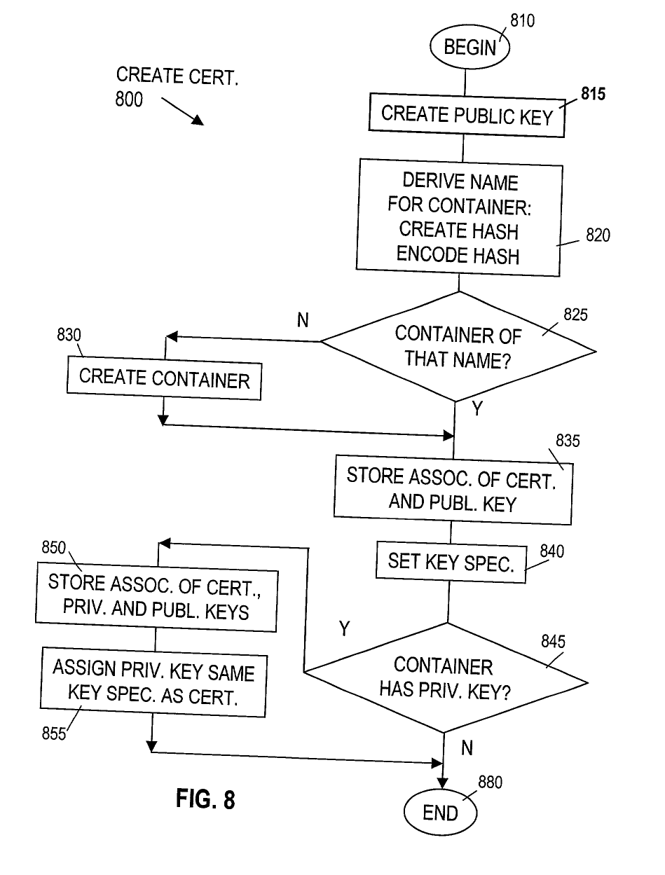

Referring now to FIG. 8, a method 800 is illustrated, according to an embodiment of the invention. Method 800 is included in method 125 (FIG. 1), and supplements conventional method 115 (FIG. 1) for creating a public key certificate. The method 800 begins at step 810 responsive to an application calling for method 115 to create a public key. At step 815 a public key is created. At step 820 a name is derived from the public key for a key container. In the embodiment, this includes creating a hash and encoding the hash, as has been described herein above. Then, at 825, the names of all the containers on the smart card 170 (FIG. 1) are compared with the derived name to see if there is a container of that name on the smart card 170. If not, then at 830 a container is created and assigned the derived name. If there is a container with the derived name, then at 835 association of the certificate and public key is stored, and at 840 the public key is assigned a specification. (Step 840 will be described further herein below.) Next, at 845, a determination is made as to whether the container has a private key for the public key and certificate. If not, the method 800 ends at step 880. Otherwise, at step 850 associations of the certificate, private key and public key are stored. Then, at 855, the private key is assigned the same key specification as the associated certificate, and then the method 800 ends at step 880.

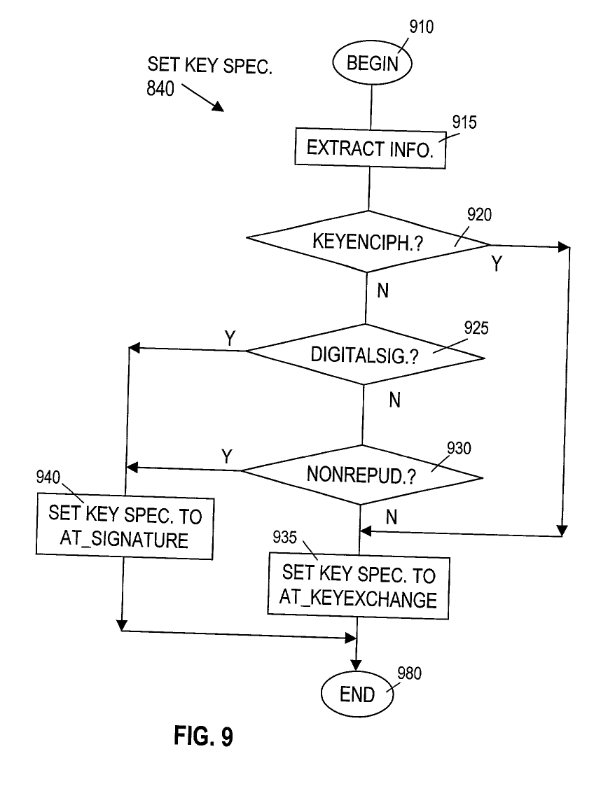

Referring now to FIG. 9, a method 840 included in method 800 (FIG. 8) is illustrated, according to an embodiment of the invention. The method 840 begins at 910. Next, at 915 information is extracted from the certificate, as has been described herein above in connection with FIG. 4. If, at step 920, it is determined that “keyEncipherment” is present in the key usage specifying information 450 (FIG. 4), then the key specification is set to “AT_KEYEXCHANGE” at 935, and the method 840 ends at 980. If, at step 925, it is determined that “digitalSignature” is present in the key usage specifying information, then the key specification is set to “AT_SIGNATURE” at 940, and the method 840 ends at 980. If, at step 930, it is determined that “nonRepudiation” is present in the key usage specifying information, then the key specification is set to “AT_SIGNATURE” at 940, and the method 840 ends at 980. Otherwise, the key specification is set to “AT_KEYEXCHANGE” at 935, and the method 840 ends at 980.

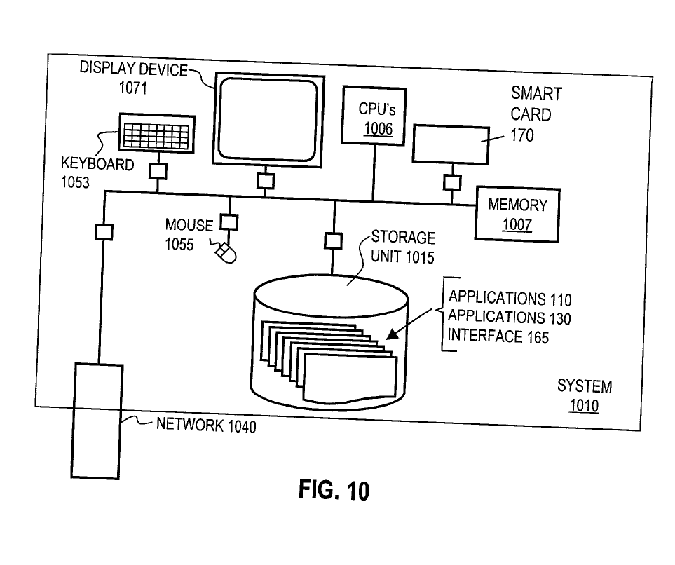

Referring now to FIG. 10, a computer system 1010 is illustrated for an embodiment of the present invention. Computer system 1010 has one or more central processors (“CPU's”) 1006 connected to a network 1040, and includes interface devices such as keyboard 1053, mouse 1055 and display device 1071. The system 1010 has a disk storage unit 1015 and memory 1007, such as random access memory, coupled to CPU's 1006. The storage unit 1015 is for storing programs and data, including applications 110 and 130 and interface 165 (FIG. 1). The programs, etc. are operable to be selectively moved from the storage unit 1015 to memory 1007 for execution by the CPU's 1006, thereby causing the system 1010 to perform operations as described herein above.

The storage model of the embodiment is a superset of the storage models for PKCS #11 and the CSP. Table 1 shows attributes of the public key, private key and certificate objects. The check marks indicate object classes to which the attributes belong. Each row describes one attribute and include the attribute names, as referred to according to the PKCS #11 and CSP conventions. In cases where there is not a one-to-one mapping, such as the key container case described in detail herein above, the table describes how the invention provides interoperability, including how supplemental aspects of cryptographic material are created for rendering the material compatible with two Cryptographic-related API's. In cases where there is a one-to-one mapping, such as the case where PKCS #11 uses the term “CKA _MODIFIABLE” and CryptoAPI has a corresponding term “CRYPT_WRITE,” the supplemental aspect may be simply material such as a table indicating a cross-reference between the terms.

From the foregoing it should be appreciated that the invention illustrated in the embodiment provides significant advantages. While cryptographic API standards such as PKCS #11 and CryptoAPI are not sufficiently specific to guarantee full interoperability among applications, such as applications 110 and 130 (FIG. 1) for example, the invention nevertheless does extend the degree of their interoperability. Otherwise, even strict adherence to current industry standard protocols for storage, communication and procedures by each individual application developer would not be sufficient to achieve successful cross-application usage of cryptographic material such as cryptographic keys. In theory interoperability could be achieved through reconciliation of various standards, but this is not realistic because it is so difficult to achieve. PKCS #15 is currently based on the ISO 7816-4 file system, while the smart card industry is moving towards Java Card. Neither PKCS #11 nor PKCS #15 supports certain CryptoAPI features, and vice versa. For example, the key container concept is not shared by PKCS #11 and CryptoAPI. Moreover, the standards are numerous. In particular, relevant standards include MD2, MD5 and SHA-1 one-way functions, combined with PKCS #1 (RSA) encryption and PKCS #7 message syntax standards for electronic signatures; X.509 for public key certificates; and DES, 3DES, RC2, RC4, RC5, AES, etc. in combination with PKCS #1 and PKCS #7 for bulk data encrypting. Furthermore, even if strict adherence to relevant ones of these many standards could be achieved and the standards were reconciled, the combination of these standards may not provide adequate security for cryptographic applications. Therefore, the alternative offered by the present invention is particularly advantageous. The description of the present embodiment has been presented for purposes of illustration, but is not intended to be exhaustive or to limit the invention to the form disclosed. Many additional aspects, modifications and variations are also contemplated and are intended to be encompassed within the scope of the following claims. For example, it is important to note that while the present invention has been described primarily in the context of a RSA public key cryptography system, and in the context of PKCS #11 and CryptoAPI, those of ordinary skill in the art will appreciate that at least certain aspects of the invention may be implemented in a different context, such as that of PKCS #3, CDSA, DSA, Diffie Helman, elliptic curve, DSS, ElGamal, DES, or other cryptographic related algorithms. To give one specific example, which should not be taken as a limitation, container name derivation may be implemented for other public key cryptosystems such as DSA, Diffie Helman, elliptic curve, etc. using other unique information from the key pair, message digest functions other than MD5, and encoding methods other than GUID-style encoding.

Also, the the present invention has been described primarily in the context of a host accessing cryptographic material on a smart card, but those of ordinary skill in the art will appreciate that the cryptographic material may be accessed by some device other than a host and the material may be on some device other than a smart card. Furthermore, processes of the present invention are capable of being distributed in the form of a computer readable medium of instructions in a variety of forms. The present invention applies equally regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

Method steps are shown herein and described in a particular sequence, i.e., order. However, it should be understood that in other embodiments these steps may be done in different sequences. The invention is not limited to the particular sequences described, nor necessarily limited to the order of steps set out in the claims.

TABLE 1

| Attribute as known to PKCS #11 | Public key | Private | Certificat | Attribute as known to CSP |
|---|---|---|---|---|
| CKA_PRIVATE | ✓ | ✓ | ✓ | An implicit counterpart. The CSP will |
| | | | | create Public Key and Certificate objects |
| | | | | with value FALSE and Private Key |
| | | | | objects with value TRUE. It will use this |
| | | | | attribute to determine the need to pop up |
| | | | | a dialog to do card holder verification. |
| CKA_MODIFIABLE | ✓ | ✓ | ✓ | CRYPT_WRITE |
| CKA_LABEL | ✓ | ✓ | ✓ | No counterpart. The CSP assigns the |
| | | | | following value on the creation of these |
| | | | | objects. |
| | | | | “<cn>'s<o>ID” |
| | | | | where <cn> is the common name attribute |
| | | | | in the Certificate subject and <o> is the |
| | | | | organization attribute in the Certificate |
| | | | | issuer. |
| | | | | Example: “John Smith's Verisign Ltd |
| | | | | ID”. (The label could be set to other |
| | | | | meaningful text.) The attribute is never |
| | | | | read. |
| CKA_ID | ✓ | ✓ | ✓ | No counterpart. In the present |
| | | | | embodiment, the CSP assigns the |
| | | | | following value on the creation of these |
| | | | | objects: The 20 byte SHA-1 hash of the |
| | | | | big endian RSA modulus including a |
| | | | | leading zero byte. (The ID could be |
| | | | | derived using other functions.) The |
| | | | | attribute is never read. |
| CKA_ISSUER | | | ✓ | No counterpart. The CSP extracts this |
| | | | | value from the certificate. The attribute is |
| | | | | never read. |
| CKA_SUBJECT | ✓ | ✓ | ✓ | No counterpart. The CSP extracts this |
| | | | | value from the certificate. The attribute is |
| | | | | never read. |
| CKA_SERIAL_NUMBER | | | ✓ | No counterpart. The CSP extracts this |
| | | | | value from the certificate. The attribute is |
| | | | | never read. |
| CKA_VALUE | | | ✓ | Corresponds to the certificate blob |
| | | | | accessed by CryptGetKeyParam and |
| | | | | CryptSetKeyParam using the |
| | | | | KP_CERTIFICATE option. |
| CKA_START_DATE | ✓ | ✓ | | No counterpart. The CSP doesn't set - or |
| | | | | read this attribute. |
| CKA_END_DATE | ✓ | ✓ | | No counterpart. The CSP doesn't set - or |
| | | | | read this attribute. |
| CKA_DERIVE | ✓ | ✓ | | No counterpart. CSP will set it to TRUE |
| | | | | when public key is created. |
| | | | | CryptDeriveKey will fail if its value is |
| | | | | FALSE. |
| CKA_LOCAL | ✓ | ✓ | | No counterpart. The CSP sets it to TRUE |
| | | | | when keys are generated on the card, |
| | | | | otherwise false. The attribute is never |
| | | | | read. |
| CKA_ENCRYPT | ✓ | | | CRYPT_ENCRYPT |
| CKA_WRAP | ✓ | | | No counterpart. The CSP sets it to TRUE |
| | | | | when a public key is created. |
| | | | | CryptExportKey will fail if its value is |
| | | | | FALSE. |
| CKA_DECRYPT | | ✓ | | CRYPT_DECRYPT |
| CKA_UNWRAP | | ✓ | | No counterpart. The CSP sets it to TRUE |
| | | | | when a private key is created. |
| | | | | CryptImportKey will fail if its value is |
| | | | | FALSE. |
| CKA_VERIFY | ✓ | | | No counterpart. The CSP will set it to |
| | | | | TRUE when a public key is created. |
| | | | | CPVerifySignature will fail if its value is |
| | | | | FALSE. |
| CKA_VERIFY_RECOVER | ✓ | | | No counterpart. The CSP will set it to |
| | | | | TRUE when public key is created. The |
| | | | | attribute is never read. |
| CKA_SIGN | | ✓ | | No counterpart. The CSP will set it to |
| | | | | TRUE when a private key is created. |
| | | | | CryptSignHash will fail if its value is |
| | | | | FALSE. |
| CKA_SIGN_RECOVER | | ✓ | | No counterpart. The CSP will set it to |
| | | | | TRUE when private key is created. The |
| | | | | attribute is never read. |
| CKA_EXTRACTABLE | | ✓ | | CRYPT_EXPORT |
| CKA_SENSITIVE | | ✓ | | CRYPT_READ. CKA_SENSITIVE and |
| | | | | CRYPT_READ are negations of each |
| | | | | other. |
| CKA_ALWAYS_SENSITIVE | | ✓ | | No counterpart. The CSP sets it to |
| | | | | opposite value of CRYPT_READ. The |
| | | | | attribute is never read. |
| CKA_NEVER_EXTRACTABLE | | ✓ | | No counterpart. The CSP sets it to the |
| | | | | same value as CRYPT_EXPORT. The |
| | | | | attribute is never read. |
| CKA_MODULUS | ✓ | ✓ | | modulus attribute in the dynamic |
| | | | | structure described by |
| | | | | PRIVATEKEYBLOB |
| CKA_PUBLIC_EXPONENT | ✓ | ✓ | | pubexp in the RSAPUBKEY struct. |
| CKA_PRIVATE_EXPONENT | | ✓ | | privateExponent attribute in the dynamic |
| | | | | structure described by |
| | | | | PRIVATEKEYBLOB |
| CKA_PRIME_1 | | ✓ | | prime1 attribute in the dynamic structure |
| | | | | described by PRIVATEKEYBLOB |
| CKA_PRIME_2 | | ✓ | | prime2 attribute in the dynamic structure |
| | | | | described by PRIVATEKEYBLOB |
| CKA_EXPONENT_1 | | ✓ | | exponent1 attribute in the dynamic |
| | | | | structure described by |
| | | | | PRIVATEKEYBLOB |
| CKA_EXPONENT_2 | | ✓ | | exponent2 attribute in the dynamic |
| | | | | structure described by |
| | | | | PRIVATEKEYBLOBJ |
| CKA_COEFFICIENT | | ✓ | | coefficient attribute in the dynamic |
| | | | | structure described by |
| | | | | PRIVATEKEYBLOB |

What is claimed is:

1. A method for accessing cryptographic material comprising the steps of:
creating cryptographic material, by a first Cryptographic-related application programming interface (“API”), in response to a request by a first application compatible with the first Cryptographic-related API; and
creating a supplemental aspect of the cryptographic material by a supplemental method for the first cryptographic API, wherein the supplemental aspect includes information for rendering the cryptographic material compatible with a second Cryptographic-related API so that the cryptographic material is accessible for a second application by the second Cryptographic-related API.

2. The method of claim 1, wherein the step of creating cryptographic material comprises creating a certificate or private key, and the step of creating the supplemental aspect of the cryptographic material comprises the steps of:
deriving a key container name from the certificate or private key; and
determining whether the key container already exists.

3. The method of claim 2, wherein the step of deriving a key container name comprises the steps of:
creating a hash responsive to material from the certificate or private key; and
encoding the hash.

4. The method of claim 2, wherein the step of creating a certificate or private key comprises creating the private key and wherein if the key container already exists for the key, the step of creating the supplemental aspect of the cryptographic material comprises the steps of:
determining whether the key container contains a certificate;
associating the private key as a member of a key pair associated with the certificate, if the key container contains a certificate; and
associating the private key as a member of a key pair having a default key specification, if the key container does not contain a certificate.

5. The method of claim 2, wherein the step of creating a certificate or private key comprises creating the certificate, and the step of creating the supplemental aspect of the cryptographic material comprises the steps of
extracting a key specification from the certificate; and
associating the certificate with a key pair under the extracted key specification.

6. The method of claim 2, wherein the step of creating a certificate or private key comprises creating the certificate, and wherein if the key container already exists for the certificate the step of creating the supplemental aspect of the cryptographic material comprises the steps of:
determining whether the key container has a private key; and
associating the private key with a same key pair as the certificate, if the key container has the private key.

7. The method of claim 2, wherein the step of creating a certificate or private key comprises creating the certificate, and the step of creating the supplemental aspect of the cryptographic material comprises the step of:
creating a public key from information in the certificate.

8. The method of claim 1, wherein the first Cryptographic-related API is one from the set of PKCS #11, CryptoAPI, and CDSA compatible API's, and the second Cryptographic-related API is not the same API as the first and is also one from the set of PKCS #11, CryptoAPI and CDSA compatible API's.

9. The method of claim 1, wherein the first Cryptographic-related API uses a certain term and the second Cryptographic-related API has a corresponding term, and wherein creating the supplemental aspect comprises creating material indicating a cross-reference between the

10. A computer program product for accessing cryptographic material comprising:
first instructions for creating cryptographic material, by a first Cryptographic-related application programming interface (“API”), in response to a request by a first application compatible with the first Cryptographic-related API; and
second instructions for creating a supplemental aspect of the cryptographic material for the first cryptographic API, wherein the supplemental aspect includes information for rendering the cryptographic material compatible with a second Cryptographic-related API so the cryptographic material is accessible for a second application by the second Cryptographic-related API.

11. The computer program product of claim 10, wherein the first instructions comprise instructions for creating a certificate or private key, and the second instructions comprise:
instructions for deriving a key container name from the certificate or private key; and
instructions for determining whether the key container already exists.

12. The computer program product of claim 11, wherein the instructions for deriving a key container name comprise:
instructions for creating a hash responsive to material from the certificate or private key; and
instructions for encoding the hash.

13. The computer program product of claim 11, wherein the instructions for creating a certificate or private key comprise instructions for creating the private key, and the second instructions comprise:
instructions for determining whether the key container contains a certificate, if the key container does already exist for the key;
instructions for associating the private key as a member of a key pair associated with the certificate, if the key container contains a certificate; and
instructions for associating the private key as a member of a key pair having a default key specification, if the key container does not contain a certificate.

14. The computer program product of claim 11, wherein the instructions for creating a certificate or private key comprise instructions for creating the certificate, and the second instructions comprise:
instructions for extracting a key specification from the certificate; and
instructions for associating the certificate with a key pair under the extracted key specification.

15. The of claim 11, wherein the instructions for creating a certificate or private key comprise instructions for creating the certificate, and wherein the second instructions comprise:
determining whether the key container has a private key, if a key container does already exist for the certificate; and
associating the private key with a same key pair as the certificate, if the key container has the private key.

16. The computer program product of claim 11, wherein the instructions for creating a certificate or private key comprise instructions for creating the certificate, and wherein the second instructions comprise:
instructions for creating a public key from information in the certificate.

17. The computer program product of claim 10, wherein the first Cryptographic-related API is one from the set of PKCS #11, CryptoAPI, and CDSA compatible API's, and the second Cryptographic-related API is a different API than the first Cryptographic-related API and is also one from the set of PKCS #11, CryptoAPI and CDSA compatible API's.

18. The computer program product of claim 10, wherein the first Cryptographic-related API uses a certain term and the second Cryptographic-related API has a corresponding term, and wherein the instructions for creating the supplemental aspect comprise instructions for creating material indicating a cross-reference between the terms.

19. An apparatus for accessing cryptographic material comprising:
a processor; and
a memory coupled to the processor for storing instructions for controlling the processor, wherein the processor is operative with the instructions to perform the steps of:
a) creating cryptographic material, by a first Cryptographic-related application programming interface (“API”), in response to a request by a first application compatible with the first Cryptographic-related API; and
b) creating a supplemental aspect of the cryptographic material by a supplemental method for the first cryptographic API, wherein the supplemental aspect includes information for rendering the cryptographic material compatible with a second Cryptographic-related API so that the cryptographic material is accessible for a second application by the second Cryptographic-related API.

20. The apparatus of claim 19, wherein step a) comprises creating a certificate or private key, and step b) comprises the steps of:
deriving a key container name from the certificate or private key; and
determining whether the key container already exists.

21. The apparatus of claim 20, wherein the step of deriving a key container name comprises the steps of:
creating a hash responsive to material from the certificate or private key; and
encoding the hash.

22. The apparatus of claim 20, wherein the step of creating a certificate or private key comprises creating the private key and wherein if the key container already exists for the key, step b) comprises the steps of:
determining whether the key container contains a certificate;
associating the private key as a member of a key pair associated with the certificate, if the key container contains a certificate; and
associating the private key as a member of a key pair having a default key specification, if the key container does not contain a certificate.

23. The apparatus of claim 20, wherein the step of creating a certificate or private key comprises creating the certificate, and step b) comprises the steps of:
extracting a key specification from the certificate; and
associating the certificate with a key pair under the extracted key specification.

24. The apparatus of claim 20, wherein the step of creating a certificate or private key comprises creating the certificate, and wherein if the key container already exists for the certificate step b) comprises the steps of:
determining whether the key container has a private key; and
associating the private key with a same key pair as the certificate, if the key container has the private key.

25. The apparatus of claim 20, wherein the step of creating a certificate or private key comprises creating the certificate, and step b) comprises the step of:
creating a public key from information in the certificate.

26. The apparatus of claim 19, wherein the first Cryptographic-related API is one from the set of PKCS #11, CryptoAPI, and CDSA compatible API's, and the second Cryptographic-related API is not the same API as the first and is also one from the set of PKCS #11, CryptoAPI and CDSA compatible API's.

27. The apparatus of claim 19, wherein the first Cryptographic-related API uses a certain term and the second Cryptographic-related API has a corresponding term, and wherein creating the supplemental aspect comprises creating material indicating a cross-reference between the term
